(19) United States
(12) Patent Application Publication
(10) Pub. No.: US 2025/0048998 A1
(43) Pub. Date: Feb. 13, 2025

(54) PET LEASH WITH ADJUSTABLE CONCEALING CONTROL HANDLE

(71) Applicants: Howard Lloyd Boggan, II, Newtown, OH (US); Candace Mishon Boggan, Celebration, FL (US)

(72) Inventors: Howard Lloyd Boggan, II, Newtown, OH (US); Candace Mishon Boggan, Celebration, FL (US)

(21) Appl. No.: 18/232,365

(22) Filed: Aug. 10, 2023

(51) Int. Cl. A01K 27/00

(52) U.S. Cl. CPC A01K 27/003

(57) ABSTRACT

An adjustable pet leash which offers a secondary control handle capable of being slidably positioned and locked in a fixed position at any desired point upon the leashes tether. The leash has a secondary control handle assembly which allows the grip of the handle assembly to be slidably positioned upon a primary looped handle at the proximal end of the leash to return the leash into a sleek thin lightweight traditional leash without the hanging obstruction of the secondary handle dangling from the leashes tether. Additionally, control leash is simple to operate without complicated numerous pieces of hardware and it is comfortable for all ages of pet handlers.

### CROSS-REFERENCE TO RELATED APPLICATIONS

None.

### STATEMENT REGARDING FEDERALLY SPONSORED RESEARCH OR DEVELOPMENT

None

### REFERENCE TO A SEQUENCE LISTING

None

### BACKGROUND OF THE INVENTION

There are various types of pet leashes known in the prior art. Many of which attempt to address issues relating to both the control and the distance of an animal during walking or exercising. Typically, a pet handler allows the animal to walk either in front or along the side of them. This method allows the animal to move freely with minimal restrictions. Quite often the handler needs to draw the animal closer to them and in doing so they grab a desired point onto the leashe's tether.

Most leashes are composed of materials, which make up the leashe's tether, that are thin and sleek and do not offer much resistance from a hand slipping upon them. In order to counter this problem handlers often grab and wrap the leashes tether around the hand in order to shorten the distance between themselves and the pet which can be time consuming and possibly injurious. In an effort to improve this practice, prior art contained in the design of pet leashes discloses various types of pet leashes that have been modified to include secondary handles or gripping mechanisms to prevent a handler's hand from slipping while attempting to reduce the distance between themselves and the pet and to gain better control of the pet. Many of these attempted corrections in the prior art are flawed. For example, U.S. Pat. No. 6,453,851 B1 discloses a leash having a device which serves as a secondary hand grip used slidably along the leashe's tether which requires the user to depress upon said device at any desired point of the leashes tether by use of the user's thumb. This action attempts to allow for the user to either draw the pet closer or further away from the handler for purposes of better control or to allow for more freedom of space while walking or exercising. The continuous effort required to maintain constant pressure on said device over a period of time can be painful and may result in injury. Additionally, the animal may overpower the physically limited use of force required by the user's thumb depressed upon the device and unexpectedly relocate the position of said device defeating the device's purpose.

Another example is U.S. Pat. No. 5,649,504 which discloses a pet leash designed with a primary handle, proximate to the user, and a stationary secondary handle distal to the user located near the pets collar or harness and the attachment area to said collar or harness. Said secondary handle does not allow for adjustment of its position and limits its effectiveness for handling smaller or shorter animals. Said secondary handle would be out of reach while walking a small pet. The stationary manner in which the secondary handle is located leaves a looped article of material in an open position which could also become snagged upon an object such as a bush or twig from a low standing tree or any other type of object along a path or trail. Another example of a failed attempt is U.S. Pat. No. 7,096,827 B2 which discloses a leash with multiple adjustment mechanisms designed for walking either one or multiple pets. This particular article of the prior art overthinks the simplistic purpose of a pet leash and involves numerous points of adjustment causing the leash to be complicated in use for an older person or a handler intimidated by multiple gadgets and or the actions required to be performed in order to use it. Said leash is also bulky in size and substantial in weight making it less ideal for either an older pet handler or one that is less physically capable. In light of the above referenced issues contained the in prior art of pet leashes, the need for a newly improved leash which offers a secondary control handle allowing the handler to control distances between themselves and the pet while also maintaining a design that is simple, sleek and easy for all age groups to operate is needed.

### SUMMARY OF THE INVENTION

In view of the foregoing advantages and disadvantages inherent in the known types of pet leashes in the prior art, the present invention provides a new and improved leash wherein the same can be utilized for providing both control and freedom of movement while walking or exercising a pet. It is therefore an object of the present invention to provide a control leash comprising a secondary control handle assembly slidable along the length of the leashes tether to enable the user to choose and maintain a desired yet controlled distance between user and pet. It is another objective of the present invention to enable the user to engage a locking mechanism in order to set the secondary handle assembly at a desired point on the leashes tether. It is yet another objective of the present invention to provide a secondary handle assembly that is slidable over the proximal primary handle for the purpose of concealing said proximal primary handle providing the user the function and appearance of a traditional pet leash which is lightweight sleek in appearance and safe guards the secondary control handle assembly from hanging freely upon the tether when not in use.

### DESCRIPTION OF THE DRAWINGS

FIG. 1 Shows the preferred embodiment of the control leash with the secondary Control handle assembly positioned over the proximal primary handle.

FIG. 2 Shows a perspective view of the underside of the slidable locking mechanism portion of the handle assembly depicting how the secondary control handle is Received through the slots of the slide mechanism forming a loop.

FIG. 3 Shows a perspective view of the frontal portion of the locking mechanism and depicts how the leashes tether is strung through the frontal slot of the locking mechanism while the locking latch is in the unlocked position.

FIG. 4 Shows a perspective view of the secondary control handle assembly as it is Slidably positioned for allowing the hand grip unit to conceal the proximal looped primary handle.

### DETAILED DESCRIPTION OF THE INVENTION

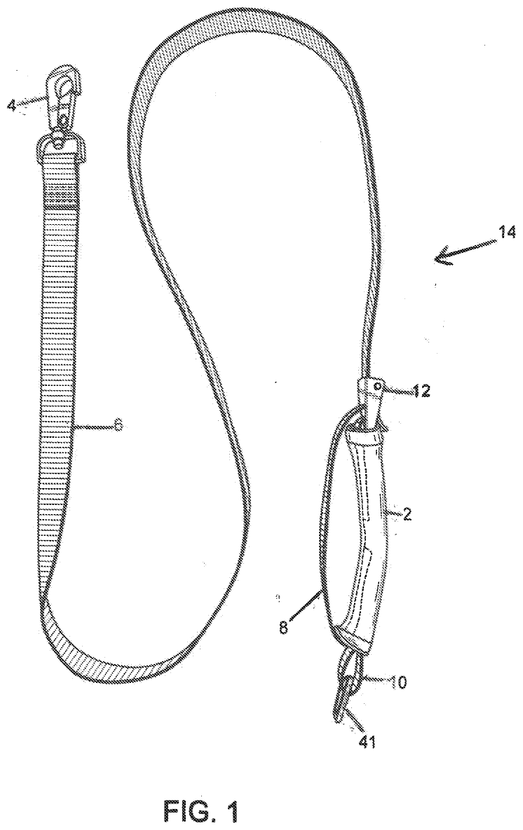

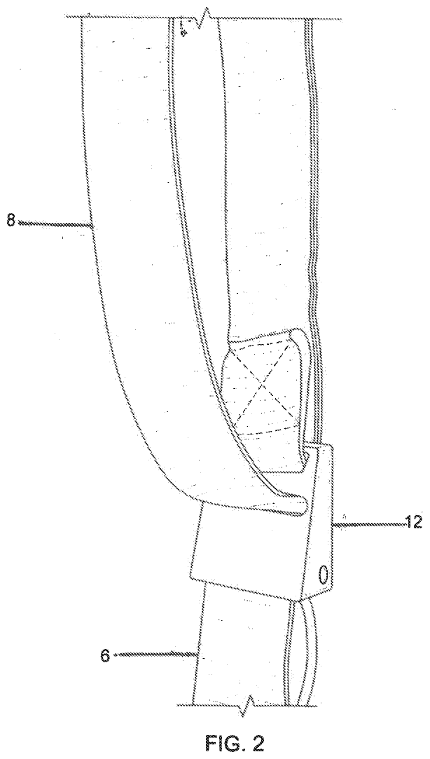

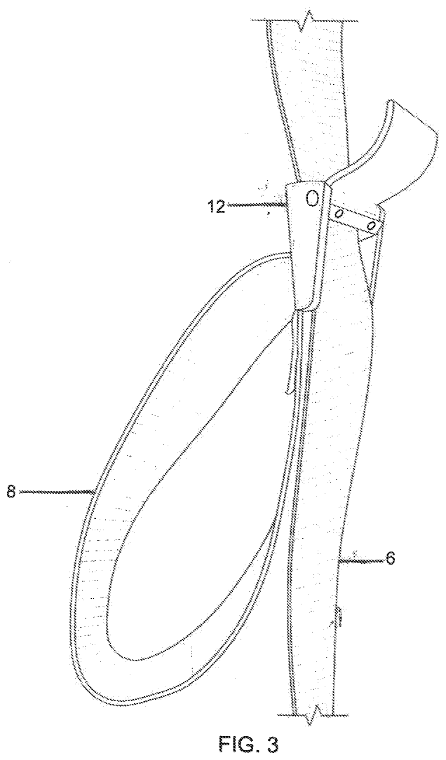

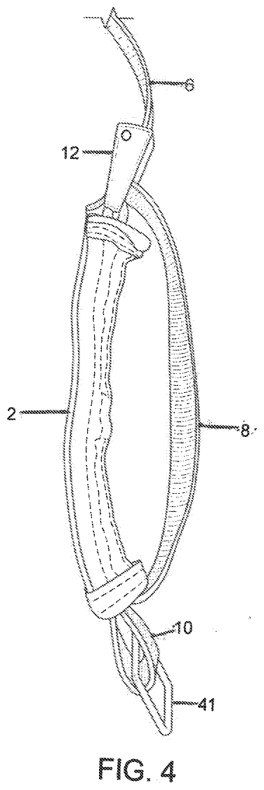

The present invention is an adjustable control leash 14 equipped with a secondary handle assembly 12, 2, 8 as depicted in FIG. 1. The leashes components, also depicted in FIG. 1, consist of a length of tether constructed of a durable material suitable to withstand pulling forces of an animal yet sleek enough to be slidably received onto a locking mechanism such as a cambuckle 12 or similar type of locking mechanism. Additionally, the adjustable leash 14 depicted in FIG. 1 consists of a distal end of tether 6 strung through and folded-over and sewn onto the opposite surface of tether 6 for means of securement of an attachment mechanism 4 such as a bolt snap or similar attachment mechanism capable of being affixed to a pets collar or harness. FIG. 1 further depicts an adjustable leash 14 having a proximal end 10 folded over and attached, preferably sewn, forming a loop which serves as a handle for the user to hold onto. The configuration shown in FIG. 1 shows the secondary control handle assembly 12, 2, 8 positioned for concealing proximal looped handle 10 leaving a small portion exposed for accessory ring 41 to hang freely for receipt of any chosen objects such as keys or possibly a poop bag container or a pet treat container to attach. Now referring to FIG. 2 which depicts an underside perspective view in closer detail of how the secondary control handle assembly is affixed to locking mechanism 12. A shorter length of durable material 8 is threaded through a top slot located on mechanism 12 then received back through a second lower slot located on mechanism 12 forming a loop handle. Now referring to FIG. 3 which depicts a frontal perspective view of the control handle assembly 12, 8 without the hand grip 2 applied in order to show how the locking mechanism 12 and affixed looped handle 8 are slidable along the length of tether 6. Now lastly referring to FIG. 4, The handle assembly 12, 2, 8 are shown as a full unit including hand grip 2. The handler lifts the lever of mechanism 12, slides the complete handle assembly to a desired location on the tether and depresses the lever into the down position locking the handle assembly for optimal control over the distance between the handler and the pet. When the handler desires, the lever is released to the open position and the handle assembly is slidably positioned back onto the primary looped handle 10, the lever is again depressed and the proximal handle is concealed and the leash takes on the appearance and function of a standard lead.

Other versions contained in the prior art which offer secondary control handles do not accomplish the ease of use the security of a locking mechanism which requires no further effort once the latch is locked at a desired point upon the leashes tether. The present invention is the only type of its kind in which the primary handle can be fully concealed to return the leash to a traditional single handle lead when the user is in a comfortable enough environment in which close proximity and control of the pet's movement are not fully needed.

What is claimed is:

1. A pet leash with an adjustable secondary control handle capable of slidably concealing the leash's primary handle.

2. A pet leash wherein claim 1, secondary control handle is an assembly of articles such as a locking mechanism, a length of tether strung through the locking mechanism forming a looped handle a handle grip which can slidably be positioned upon a primary looped handle located proximal to the handler for optimal control of a pet.

3. A pet leash wherein claim 2, said handle grip is wrapped around the leashes tether and the length of tether forming a looped secondary handle and attached by a product such as velcro or like velcro, snaps, rivets or any other means of connecting two ends of an article of material or fabric or any other article of materials used to form a hand grip.
